(19) United States
(12) Patent Application Publication
(10) Pub. No.: US 2008/0197616 A1
(43) Pub. Date: Aug. 21, 2008

(54) Debris deflection device for skates

(76) Inventor: Mark Thomas Finstad, Oak Grove, MN (US)

Correspondence Address: Mark Finstad, 4541 200th Ln, Oak Grove, MN, 55303, US

(21) Appl. No.: 12/070,425

(22) Filed: Feb. 19, 2008

Related U.S. Application Data
(60) Provisional application No. 60/902,342, filed on Feb. 20, 2007.

(51) Int. Cl. B62D 25/16

(52) U.S. Cl. 280/770

(57) ABSTRACT

Described is a device that can be attached to an in-line skate that will deflect debris such as small rocks and sticks from the immediate path of the in-line skate. The device will detect when the rear wheels leave the skating surface and will reposition so as to not interfere with the operation of the skate when the skate tips forward.

This application claims priority of provisional patent application number 60/902,342 filed Feb. 20, 2007.

### FIELD OF THE INVENTION

The present invention relates generally to the sport of roller or ice skating and more specifically to a device that will deflect debris from the path of the skate to prevent accidental falls by the skater.

### BACKGROUND OF THE INVENTION

The sport of recreational skating for enjoyment or exercise has been popular for many years. In-line skating is one of the most popular and widely practiced types of recreational skating. In line skates consist of a boot portion to support the foot and ankle, and a series of wheels attached to the sole of the boot. Unlike standard roller skates which contain 4 wheels per skate that are configured in a square or rectangular pattern, in-line skates normally have 3 to 5 wheels per skate and all wheels are lined up one behind another. This wheel configuration makes in-line roller skates operate and feel much the same as hockey ice skates.

The in-line configuration of the wheels on an in-line skate perform very well on clean, paved surfaces such as asphalt and concrete. However, in order to place 3 to 5 wheels per skate all in a row, the wheels must be spaced very close to each other. This feature on in-line skates becomes problematic when the skates are used on surfaces that may contain debris such as stones, sticks, acorns, etc. The aforementioned debris is often hard to see when skating at a fast pace. This debris can be kicked up by one of the skate wheels and become lodged between 2 of the closely spaced wheels, causing them to abruptly stop turning. Anytime a wheel on an in-line skate stops turning, it acts as a brake and can easily cause the skater to lose their balance and fall forward. Since many in-line skaters average speeds of 10-20 miles per hour, serious injury can occur to the skater if they were to fall at those speeds.

In order to avoid being injured in a fall while skating, many skaters wear protective gear such as wrist guards, knee pads, and helmets. While these safety accessories can help reduce the chance for serious injury during a fall, they do not eliminate it. Anytime that a skater falls, there is a significant chance of injury, even if the skater is wearing protective gear.

One way to reduce the chance of falling while in-line skating would be to keep the skate wheels from coming in contact with the small debris that could be lodged between the wheels. A simple approach to this problem would be to mount a deflector to the skate that would be positioned directly in front of the front wheel to deflect objects away from the wheel before they can come in contact with the wheel. This deflector would operate much the same as the front blade of a snow plow. The deflector would ride very close to the ground and would be shaped such that any object that would come in contact with the deflector would be deflected roughly perpendicular to the direction of the skate travel.

The problem with the aforementioned approach is that a device mounted in front of the front wheel of an in-line skate, close enough to the ground to be effective, would also interfere with the movement of the skate.

Since an in-line skater uses the same style to propel them self that is used by a hockey skater, the in-line skate must be able to tip forward as the skater pushes off with that skate. When this happens, all of the wheels on the skate will leave the ground with the exception of the front wheel. If there were an immoveable deflecting device mounted in front of the front wheel and very close to the ground, it would contact the ground when the skate tips forward. The solution to this problem is device that will be in position to deflect debris when all wheels are in contact with the skating surface, but will automatically reposition when the rear wheels leave the skating surface to so as to not interfere with the operation of the skate.

### SUMMARY OF THE INVENTION

An object of the present invention is to provide an in-line skate debris deflector that will deflect small debris from the immediate path of an in-line skate.

Another object of the present invention is to provide an in-line skate debris deflector that will deflect small debris from the immediate path of an in-line skate that can be easily installed on a wide variety of in-line skate brands and styles.

Another object of the present invention is to provide an in-line skate debris deflector that will detect when the rear wheels leave the skating surface and will automatically reposition so as to not interfere with the operation of the skate.

Another object of the present invention is to provide an in-line skate debris deflector that will be inexpensive.

Another object of the present invention is to provide an in-line skate debris deflector that can be incorporated as an integral part of an in-line skate.

### BRIEF DESCRIPTION OF THE DRAWINGS

FIG. 1 is a side plan view of the preferred embodiment of the debris deflection device attached to a common in-line skate with the deflection blade in the lowered position.

FIG. 2 is a side plan view of the preferred embodiment of the debris deflection device attached to an ordinary in-line skate with the deflection blade in the raised position.

FIG. 3 is a north west isometric view of the preferred embodiment of the debris deflection device with the skate boot removed for clarity

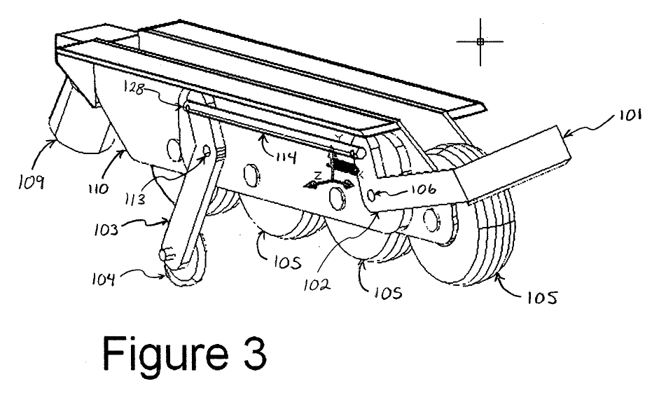

FIG. 4 is a side plan view of the alternate embodiment of the debris deflection device showing the a pivoting rear wheel in the lower position with the skate boot removed for clarity

FIG. 5 is a wire frame drawing, bottom view of the preferred embodiment of the debris deflection device with the skate boot removed for clarity

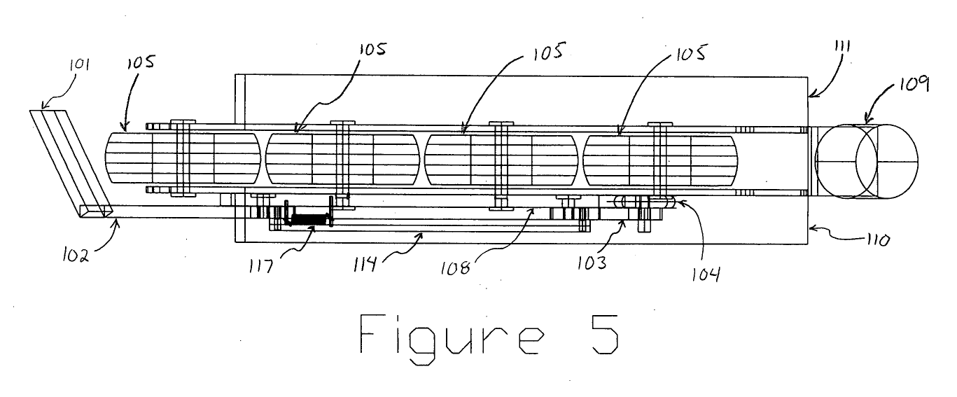

FIG. 6 is a north east isometric view of the preferred embodiment of the debris deflection device with the skate boot removed for clarity with the deflector arm in the upper position

FIG. 7 is a side plan view of the alternate embodiment of the debris deflection device showing the a pivoting rear wheel in the upper position with the skate boot removed for clarity

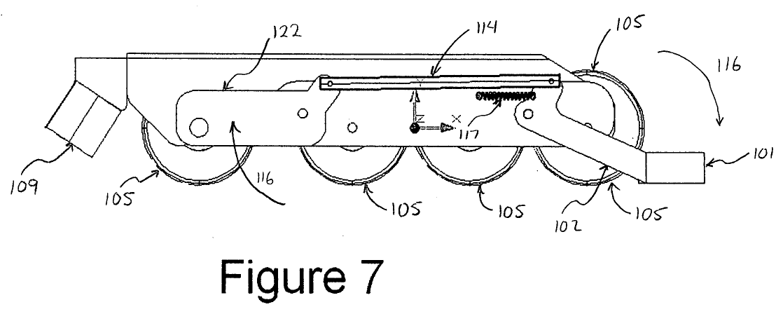

FIG. 8 is a side plan view of the preferred embodiment of the debris deflection device attached to a common in-line skate with the deflection blade in the lowered position with the skate boot removed for clarity

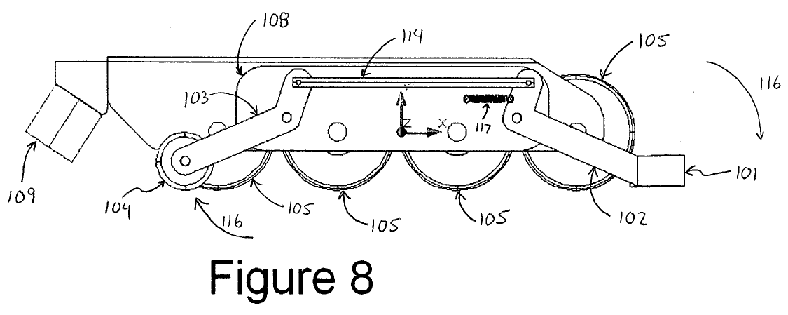

FIG. 9 is a front view of the preferred embodiment of the debris deflection device attached to a common in-line skate with the deflection blade in the lowered position.

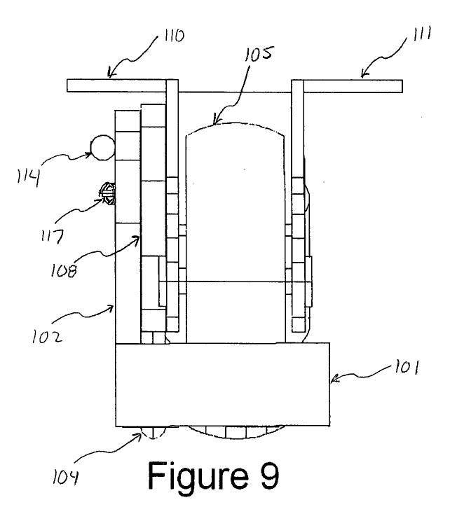

FIG. 10 is an exploded view of another embodiment of the debris deflection device, which uses a belt and pulleys to communicate mechanical movement from the detector arm to the deflector arm

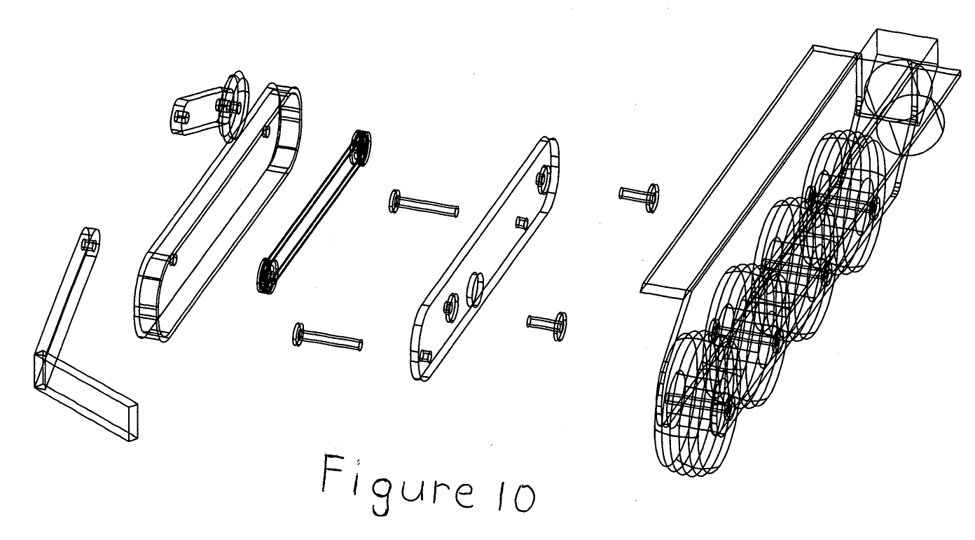

FIG. 11 is wire frame drawing, southeast view showing the deflection blade constructed from a thin, resilient material

FIG. 12 is a wire frame drawing, southeast view showing the deflection blade constructed from bristles

FIG. 13 is a parts list.

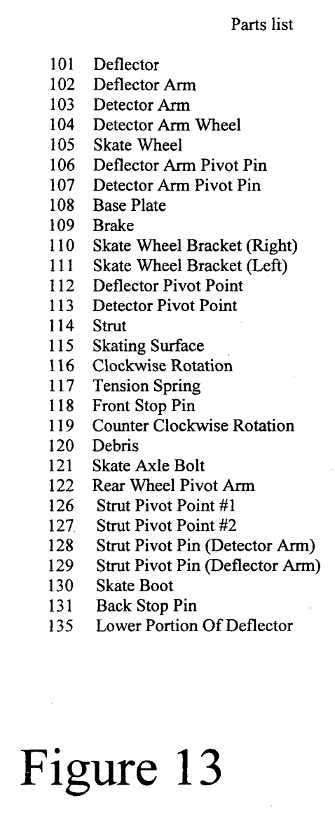

### DETAILED DESCRIPTION OF THE PREFERRED EMBODIMENTS

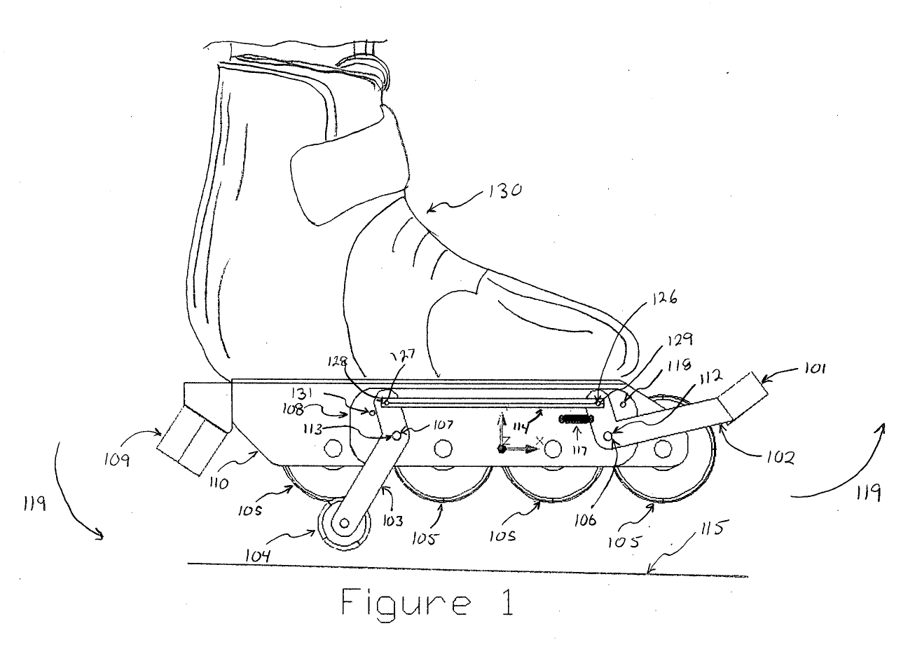

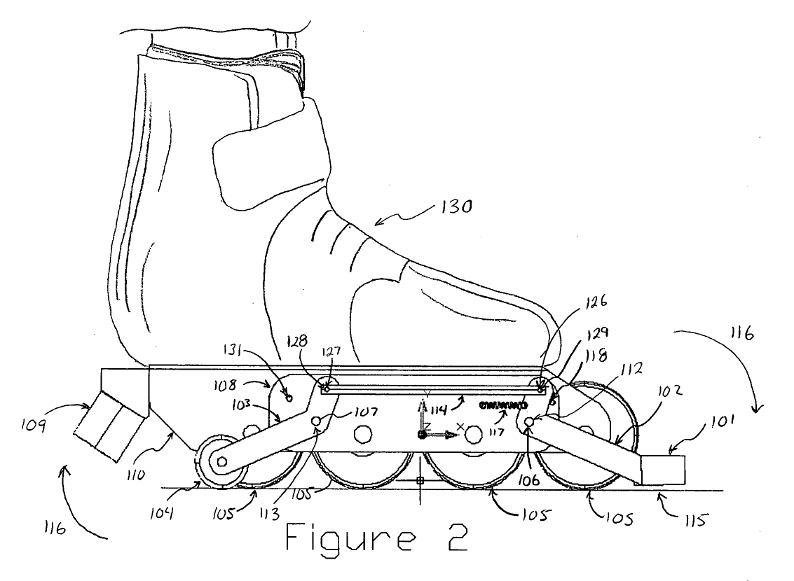

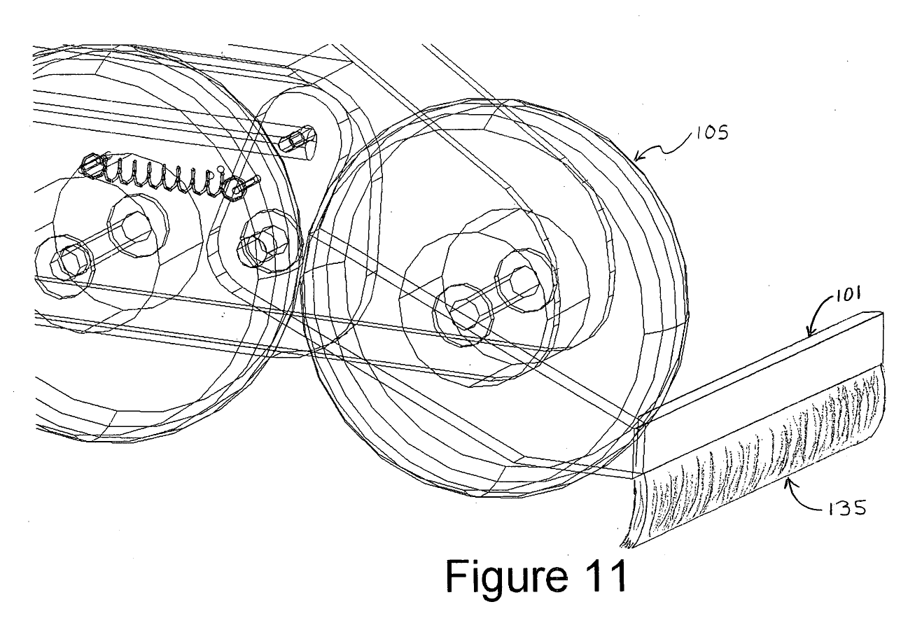

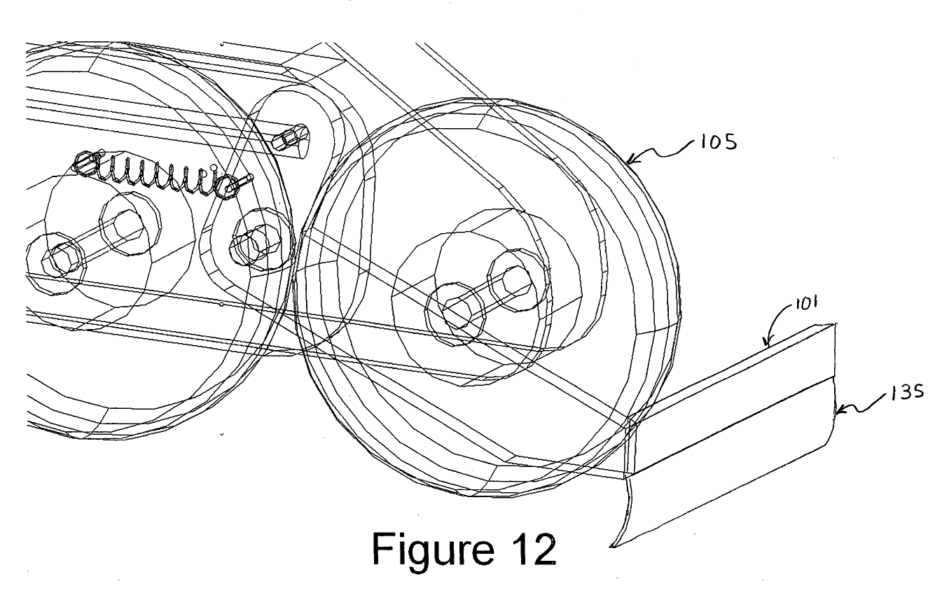

The debris deflector for skate is particularly illustrated in FIGS. 1-X. FIG. 1 illustrates the present invention attached to an in-line skate with the deflector blade 101 in the lowered position. The deflector 101 is attached to the deflector arm 102. The attachment method is such that the deflector may be easily replaced without the aid of tools if it becomes damaged. The deflector 101 may be constructed from a very brittle material, which would allow it to break free of the device in the event it collides with a large or immoveable object. In the preferred embodiment (shown in FIG. 11), the lower portion 135 of the deflector 101 is constructed from a resilient material, or a combination of materials, such as rubber, soft plastic, or glass reinforced Teflon. A suitable resilient material will be robust enough to maintain its shape when contacting small sticks and pebbles, but not so robust that it will interfere with the operation of the skate should it come in contact with a large or immoveable object. In this embodiment, the lower portion 135 of the deflector 101 would simply deform in the event of a collision with a large or immoveable object. In an alternate construction of the preferred embodiment (illustrated in FIG. 12), the lower portion 135 of the deflector 101 is constructed from a tight array of bristles, similar to a broom. The deflector arm 102 is preferably constructed from an unbreakable plastic such as acrylic, polycarbonate, or similar material. FIG. 2 illustrates the present invention attached to an in-line skate with the deflector blade 101 in the raised position.

As shown in FIGS. 1 and 2, the deflector arm 102 is attached to the base plate 108 at deflector pivot point 112 with deflector arm pivot pin 106. The detector arm 103 is attached to the base plate 108 at detector pivot point 113 with detector pivot pin 107. One end of the strut 114 is attached to the deflector arm 102 at pivot point 126 with pivot pin 129, and the other end of the strut 114 is attached to the detector arm 103 at pivot point 127 with pivot pin 128. The detector arm wheel 104 is attached to the bottom end of the detector arm.

As shown in FIG. 2, when all skate wheels 105 are in contact with the skating surface 115, the detector arm wheel 104 experiences upward pressure from the skating surface 115 and the detector arm 102 is rotated clockwise. This clockwise rotation 116 is communicated to the deflector arm 102 by means of the strut 114. As the deflector arm 102 is rotated clockwise 116, the deflector 101 lowers to become very close to the skating surface 115. With the deflector 101 in the lowered position, it will deflect debris 120 from the path of the skate wheels 105.

As shown in FIG. 1, when the rear skate wheels 105 are lifted from the skating surface 115, the tension spring 117 causes the detector arm 103 to rotate counter clockwise 119 until it contacts the stop pin 118. This counter clockwise rotation 119 is communicated to the deflector arm 102 via the strut 114. As the deflector arm 102 rotates counter clockwise 119, the deflector 101 rises away from the skating surface 115 so as to not interfere with the natural skating motion. The tension spring 117 function could also be accomplished with an elastic band or a torsion spring attached to the pivot pins 106,107 on the deflector arm 102 or the detector arm 103.

In the preferred use, each skate would be equipped with one debris deflection device mounted on the outer side of the skate. That is, the device would be mounted to the right side of the right skate and to the left side of the left skate. In the preferred embodiment, the debris deflection device would be attached to one of the skate wheel brackets 110, 111 using one or more modified skate axle bolts.

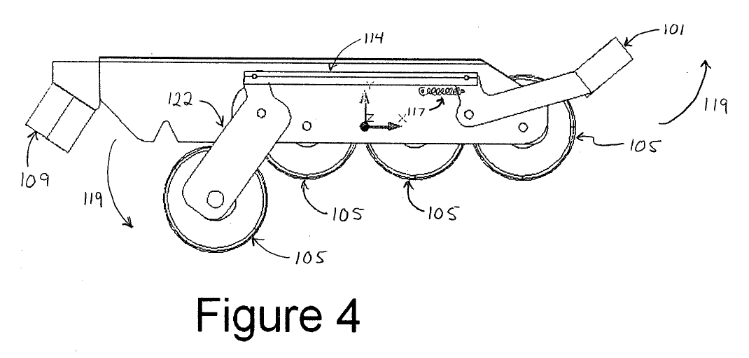

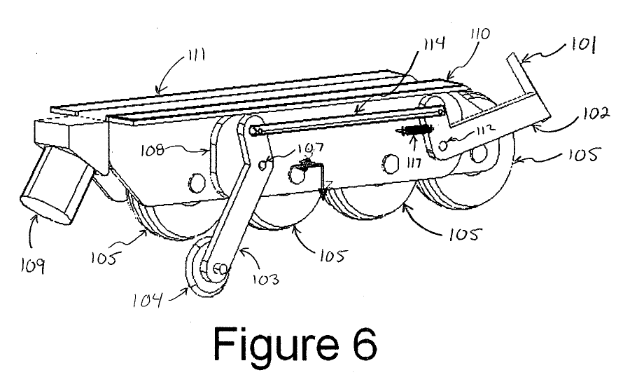

An alternate embodiment of the debris deflection device is illustrated in FIGS. 4 & 6. In this embodiment, one of the skate wheels behind the front wheel is mounted on pivot arm 122 and pivot arm 125. The skate wheel pivot arm 122 and the deflector arm 102 are pivotally attached to the strut 114. In FIG. 6, the skate is shown with the skate wheels 105 in contact with the skating surface 115. In this position, the deflector is in close contact with the skating surface thus deflecting debris from the path of the skate wheel 105. FIG. 4 illustrates the skate with some of the rear skate wheels 105 lifted off of the skating surface 115. In this position, the compression spring 124 forces the skate wheel pivot arm 122 to rotate counter clockwise 116. This counter clockwise rotation 116 is communicated to the deflector arm 102 via the strut 114, causing the deflector arm to rise away from the skating surface 115.

Having thus described in detail several embodiments of the present invention, it is to be appreciated and will be apparent to those skilled in the art that many physical changes, only a few of which are exemplified in the specification of the invention, could be made without altering the inventive concepts and principles embodied therein. It is also to be appreciated that numerous embodiments incorporating only part of the preferred embodiments are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than the foregoing description, and all alternate embodiments and changes to this embodiment which come within the meaning and range of equivalency of said claims are therefore to be embraced therein.

I claim:

1. A debris deflection device to be attached to an in-line roller skate comprising: a blade portion disposed in front of the forward most wheel of an in-line roller skate, wherein said blade portion is capable of upward and downward travel and includes an outward facing surface contoured to deflect debris, a skating surface sensing means to detect when any skate wheel behind the forward most wheel is not in contact with the skating surface, and a connection means mechanically coupling the skating surface sensing means to the blade portion so that movement of the skating surface sensing means induces movement in the blade portion, whereby positioning the skating surface sensing means in a position indicating that all skate wheels are in contact with the skating surface moves the blade portion to a lower position in close proximity to the skating surface, and positioning the skating surface sensing means in a position indicating that any of the skate wheels are not in contact with the skating surface moves the blade portion to an upper position, allowing the blade portion to deflect debris when all skate wheels are in contact with the skating surface, and allowing the blade portion to rise and reposition away from the skating surface when any rear skate wheel is not in contact with the skating surface.

2. The debris deflection device of claim 1 where the connection means is an elongated rigid member with first and second ends, wherein said first end is pivotally attached to the detector arm and said second end is pivotally attached to the deflector arm whereby movement of the detector arm is directly communicated to the deflector arm via the elongated rigid member.

3. The debris deflection device of claim 1 where the skating surface sensing means is comprised of a pivoting arm with an upper portion, a middle portion, and a lower portion, where said arm is pivotally attached the base plate in the middle portion, and where said arm contains a strut pivot point in the upper portion, and where said arm contains a wheel to contact the skating surface on the lower portion.

4. The debris deflection device of claim 1 where the skating surface sensing means is comprised of 2 pivoting arms holding a rear in-line skate wheel and allowing the wheel to drop to a lower position when the skate is lifted from the skating surface.

5. The debris deflection device of claim 1 where the blade portion is constructed from an unbreakable plastic.

6. The debris deflection device of claim 1 where the blade portion is constructed using an upper blade arm portion and a lower blade portion, wherein said upper blade arm portion is constructed from unbreakable plastic, and is molded to accept a snap-on attachment of the lower blade portion, wherein said lower blade portion is constructed from a brittle, frangible plastic thereby allowing it to break free when striking an immoveable object.

7. The debris deflection device of claim 1 further including a torsion spring coupled to the blade portion pivot point to provide upward force on the blade portion to maintain the blade in the upper position until a counter force transmitted from the sensing means forces the blade to the lower position.

8. The debris deflection device of claim 1 further including a torsion spring coupled to the skating surface sensing means pivot point to provide a downward force on the sensing means until a counter force generated by contacting the skating surface forces the skating sensing means into an upper position.

9. The debris deflection device of claim 1 further including a coil spring coupled to the blade portion, sensing means, or connection means to provide upward force on the blade portion to maintain the blade in the upper position until a counter force transmitted from the sensing means forces the blade to the lower position.

10. The debris deflection device of claim 1 further including a coil spring coupled to the skating surface sensing means pivot point to provide a downward force on the sensing means until a counter force generated by contacting the skating surface forces the skating sensing means into an upper position

11. The debris deflection device of claim 1 where the connection means is comprised of a bellow coupled to the skating surface sensing means to cause movement of air to and from the skating surface sensing means, and an air piston coupled to the blade portion, and a channel directing the flow of air from the skating surface sensing means bellow to the blade portion air piston.

12. The debris deflection device of claim 1 where the connection means is comprised of an air piston coupled to the skating surface sensing means to cause the movement of air to and from the skating surface sensing means, an air piston coupled to the blade portion which is moveable in response to air movement, and a channel directing the flow of air from the skating surface sensing means air piston to the blade portion air piston.

13. The debris deflection device of claim 1 where the connection means is comprised of a fluid piston coupled to the skating surface sensing means to cause the movement of fluid to and from the skating surface sensing means, and a fluid piston coupled to the blade portion which is moveable in response to fluid movement from the skating surface sensing fluid piston, and a channel directing a flow of fluid from the skating surface sensing means fluid piston to the blade portion fluid piston.

14. The debris deflection device of claim 1 where the connection means is comprised of a pulley on the blade portion and a pulley on the skating surface sensing means and cable connecting the pulleys.

15. The debris deflection device of claim 1 where the connection means is comprised of a pulley on the blade portion and a pulley on the skating surface sensing means and a belt connecting the pulleys.

16. The debris deflection device of claim 1 where the skating surface sensing means is comprised of a substantially U shaped bracket holding a rear skate wheel and allowing the wheel to drop to a lower position when the skate is lifted from the skating surface.

17. The debris deflection device of claim 1 where the blade portion is comprised of an upper plastic, metal, or composite structure securing a lower structure comprised of a resilient material or materials including rubber, plastic, glass reinforced Teflon, cloth or an array of bristles.

18. A debris deflection device to be attached to an in-line roller skate comprising: a blade portion disposed in front of the forward most wheel of an in-line roller skate, wherein said blade portion is capable of upward and downward travel and includes an outward facing surface contoured to deflect debris, a skating surface sensing means to detect when any skate wheel behind the forward most wheel is not in contact with the skating surface, and a connection means coupling the skating surface sensing means to the blade portion so that indication by the skating surface sensing means of the rear wheels leaving the skating surface induces movement in the blade portion, whereby when the skating surface sensing means indicates that all skate wheels are in contact with the skating surface, the blade portion moves to a lower position in close proximity to the skating surface, and when the skating surface sensing means indicates that any of the skate wheels are not in contact with the skating surface, the blade portion moves to an upper position, allowing the blade portion to deflect debris when all skate wheels are in contact with the skating surface, and allowing the blade portion to rise and reposition away from the skating surface when any rear skate wheel is not in contact with the skating surface.

19. The debris deflection device of claim 19 where the blade portion is comprised of an upper plastic, metal, or composite structure securing a lower structure comprised of a resilient material or materials including rubber, plastic, glass reinforced Teflon, cloth, or an array of bristles.
